(19) United States
(12) Patent Application Publication
(10) Pub. No.: US 2021/0174271 A1
(43) Pub. Date: Jun. 10, 2021

(54) SYSTEM AND METHOD FOR IMPLEMENTING A STANDARD OPERATING PROCEDURE (SOP) CREATION TOOL

(71) Applicant: JPMorgan Chase Bank, N.A., New York, NY (US)

(72) Inventors: Syed F. HUSSAINI, Hyderabad (IN); Sridhar RANGANABOINA, Siddipet (IN)

(21) Appl. No.: 16/702,963

(22) Filed: Dec. 4, 2019

(51) Int. Cl. G06Q 10/06; G06Q 10/10; G06F 8/10; G06F 16/25; G05B 19/042

(52) U.S. Cl. CPC G06Q 10/06; G06Q 10/10; G05B 19/0426; G06F 16/252; G06F 8/10

(57) ABSTRACT

An embodiment of the present invention is directed to a Process Discovery tool that intelligently and automatically creates SOP/Process documentation by capturing user actions. The various embodiments of the present invention may perform automatic record and intelligent step capture; apply data masking; annotate and highlight user actions; provide editing and reordering process steps; provide business and technical outputs in multiple formats including user defined templates and enable time and motion study for reengineering and automation prioritization.

### FIELD OF THE INVENTION

The invention relates generally to a system and method for implementing an intelligent standard operating procedure (SOP) document creation tool.

### BACKGROUND OF THE INVENTION

An SOP represents a procedure specific to an operation that describes activities necessary to complete tasks in accordance with various regulations, standards, etc. SOPs define expected practices in business to ensure quality compliance. In general, creating SOPs or Business Process Documents is a mundane and a time consuming task. There is potential for human errors and generating multiple versions that lead to inconsistencies.

These and other drawbacks exist.

### SUMMARY OF THE INVENTION

According to one embodiment, the invention relates to a system that implements a process discovery tool. The system comprises: a database that stores process information; an interface that receives inputs from a user device via a communication network; and a computer processor, coupled to the database and the interface, the computer processor configured to perform the steps of: receiving, via an input, process information relating to a standard operating procedure process; identifying a series of steps executing the SOP process; identifying user interaction for each step of the series of steps; executing a capture responsive to each user interaction; performing data masking to one or more data elements; graphically highlighting each user interaction for each step of the series of steps; and generating an output format that enables a review process.

According to another embodiment, the invention relates to a method that implements a process discovery tool. The method comprises the steps of receiving, via an input, process information relating to a standard operating procedure process; identifying, via a computer processor, a series of steps executing the SOP process; identifying, via the computer processor, user interaction for each step of the series of steps; executing, via the computer processor, a capture responsive to each user interaction; performing, via the computer processor, data masking to one or more data elements; graphically highlighting, via the computer processor, each user interaction for each step of the series of steps; and generating, via the computer processor, an output format that enables a review process.

The system may be implemented as a specially programmed computer system comprising one or more computer processors, interactive interfaces, electronic storage devices, and networks. The computer implemented system and method described herein provide unique advantages to entities, organizations and other users, according to various embodiments of the invention. With an embodiment of the present invention, business teams may record their processes into SOPS (or Business Process Documents). The innovative tool of an embodiment of the present invention provides significant time savings with screenshot editing options. An embodiment of the present invention captures detailed step-by-step process activities with corresponding screenshots. The innovative tool provides easy access without any machine installation, and works on standard operating system build desktop and no system prerequisite or dependencies. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart, according to an embodiment of the present invention.

FIG. 2 is an exemplary system diagram, according to an embodiment of the present invention.

FIG. 3 is an exemplary interface, according to an embodiment of the present invention.

FIG. 4 is an exemplary process discovery tool flowchart, according to an embodiment of the present invention.

FIG. 5 is an exemplary illustration of XML entities, according to an embodiment of the present invention.

FIG. 6 is an exemplary illustration of XML entities, according to an embodiment of the present invention.

FIG. 7 is an exemplary illustration of an interactive user interface, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only, It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a Process Discovery tool that intelligently and automatically creates SOP and/or Process documentation by capturing user actions. The various embodiments of the present invention may perform automatic record and intelligent step capture; apply data masking; annotate and highlight user actions; provide editing and reordering process steps; provide business and technical outputs in multiple formats including user defined templates and enable time and motion study for reengineering and automation prioritization.

An embodiment of the present invention provides intelligent capabilities and works on end user machines and/or platforms. The enterprise solution of an embodiment of the present invention may be used across industries to intelligently capture high quality business process documentation and provide business process documentation version control. An embodiment of the present invention may realize business process and unit level organizational resource utilization and efficiency reporting. In addition, the innovative tool may report and identify reengineering and automation opportunities on business operations.

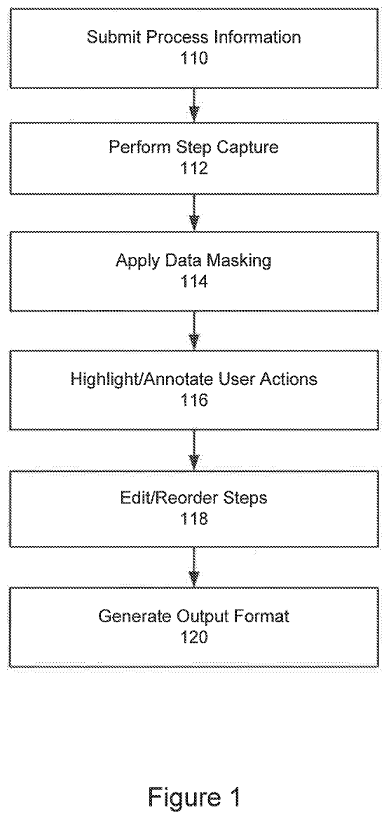

FIG. 1 is an exemplary flowchart, according to an embodiment of the present invention. At step 110, process information may be submitted. At step 112, step capture may be performed. At step 114, data masking may be applied. At step 116, user actions may be highlighted and annotated. At step 118, steps may be edited and/or reordered. At step 120, an output format may be generated. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, process information may be submitted. Process information may include data descriptive of the process. This may include systems used, data volumes, version. history, approvals as well as other details, For example, process information may relate to a policy (e.g., human resources (HR) policy) and other standards, regulations, procedures, etc.

At step 112, step capture may be performed. An embodiment of the present invention may record a set of steps that relate to an identified process. Step capture may include each user interaction with an application, module, system, component, subcomponent, etc. User interaction may involve cursor movement, user input and other interactions.

At step 114, data masking may be applied. For example, data masking may be applied to protect sensitive data. For example, security data may be obscured, redacted and/or otherwise masked.

At step 116, user actions may be highlighted and annotated. The process may highlight user actions for each step. User actions may be highlighted by a graphical interface, e.g., red box, highlighted cursor, and/or other graphic. Annotations may include explanation for a particular interaction, including warnings, commentary, links to additional data, videos, other options, etc.

At step 118, steps may be edited and/or reordered. After the initial steps are captured, a user may edit the order and/or other step details. Also, multiple steps may be merged. together. Other actions and/or edits may be performed.

At step 120, an output format may be generated. Output format may include a document, interactive interface and/or other user output. The output format may also include time and motion details and/or other additional information. Time details may include how long a process should take, as well as time breakdown for each step or collection of steps. Motion details may include interaction data, sequence data, etc. In addition, data analytics may be applied.

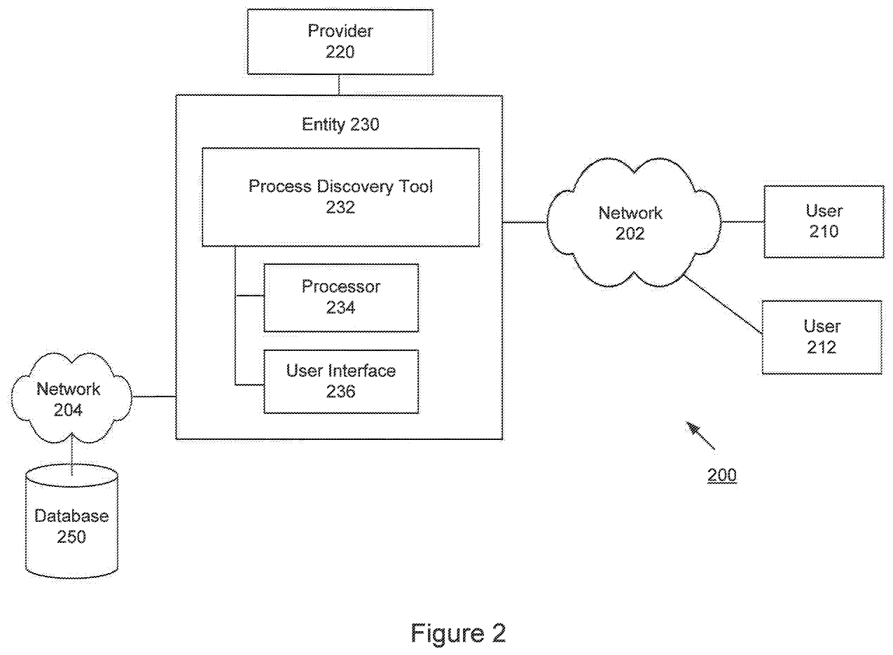

FIG. 2 is an exemplary system diagram, according to an embodiment of the present invention. As shown in FIG. 2, Entity 230 may implement Process Discovery Tool 232 that includes processing components, modules, interfaces and functions. According to an exemplary implementation, Process Discovery Tool 132 may include Processor 234, User Interface 236 and various networking and communication components. Other services and functions may be provided.

Process Discovery Tool 232 may execute one or more processors represented by 234 to perform automatic record and intelligent step capture; apply data masking; annotate and highlight user actions; edit and reorder process steps; provide business and technical outputs in multiple formats or user defined template and enable time and motion study for reengineering and automation prioritization.

User Interface 236 may display an output format that enables a user to edit and/or reorder process steps. The user may also provide commentary, instructions, descriptions, links to other sources of data, etc.

The components illustrated in FIG. 2 are merely exemplary, other devices may be represented in various applications. While a single component is illustrated, each component may represent multiple components.

Entity 230, such as a financial institution, may host Process Discovery Tool 232. Entity 230 may support Process Discovery Tool 232 as an integrated feature or system. According to another example, Process Discovery Tool 232 may be offered by a third party service provider, represented by 220. Other scenarios and architectures may be implemented. Process Discovery Tool 232 may send and/or receive data from various data sources. Data may be stored and managed in storage components, represented by Database 250, via Network 204. Entity 230 may be communicatively coupled to Databases, represented by 250. Databases 250 may include any suitable data structure to maintain the information and allow access and retrieval of the information. The storage may be local, remote, or a combination thereof with respect to Databases 250. Communications with Databases 250 may be over a network 204, or communications may involve a direct connection between Databases 250 and Entity 230, as depicted in FIG. 2. Databases 250 may also represent cloud or other network based storage.

Network 202, 204 may be communicatively coupled with various components in a network. User 210, 212 may represent various types of users, teams, etc. For example, User 210, 212 may communicate with Process Discovery Tool 232 via Network 202 through User Interface 236, Entity 230 may communicate with various users, represented by 210, 212, using any mobile or computing device, such as a laptop computer, a personal digital assistant, a smartphone, a smartwatch, smart glasses, other wearables or other computing devices capable of sending or receiving network signals.

Network 202, 204 may be a wireless network, a wired network or any combination of wireless network and wired network. Although Network 202, 204 is depicted as one network for simplicity, it should be appreciated that according to one or more embodiments, Network 202, 204 may comprise a plurality of interconnected networks, such as, for example, a service provider network, the Internet, a cellular network, corporate networks, or even home networks, or any of the types of networks mentioned above. Data may be transmitted and received via Network 202, 204 utilizing a standard networking protocol or a standard telecommunications protocol.

The system 200 of FIG. 2 may be implemented in a variety of ways. Architecture within system 200 may be implemented as hardware components (e.g., module) within one or more network elements. It should also be appreciated that architecture within system 200 may he implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 are depicted, it should be appreciated that other connections and relationships are possible. The system 200 described below may be used to implement the various methods herein, by way of example, Various elements of the system 200 may be referenced in explaining the exemplary methods described herein.

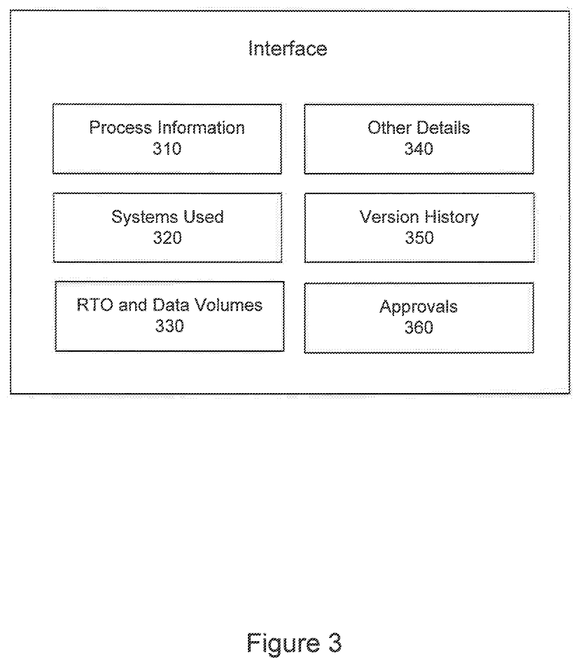

FIG. 3 is an exemplary illustration of an interactive user interface, according to an embodiment of the present invention. As shown in FIG. 3, user interface may include Process Information 310, Systems Used 320, Recovery Time Object (RTO) and Data Volumes 330, Other Details 340, Version History 350 and Approvals 360. User interlace may receive information from various sources, including a user, data interface, external data source, etc. For example, an embodiment of the present invention may electronically access process details from an application, system and/or other data source. Information may also be at least partially provided by a user. Other data sources and data inputs may be realized.

Process Information 310 may include process identifier or name and process data. Process data may include data relating to sponsor, subject matter experts (SME), business group, sub business, process country, output file path, etc.

Systems Used 320 may include application name, type, user entitlements, access information, Proof of Concept (PoC), description, etc.

Recovery Time Object (RTO) and Data Volumes 330 may include RTO (e.g., hours), strategic solution, retirement date, data volumes and capacity, disaster recovery plan, etc. This may also include RTO details, including if a system and/or application is down, what would be an alternative or backup plan.

Other Details 340 may include instructions, guidelines, standards, regulations, etc.

Version History 350 may include data relating to author, versions, data, change, etc.

Approvals 360 may identify name, identifier and type. For example, this section may identify one or more approvers and reviewers and further include corresponding details of the approval and/or review process.

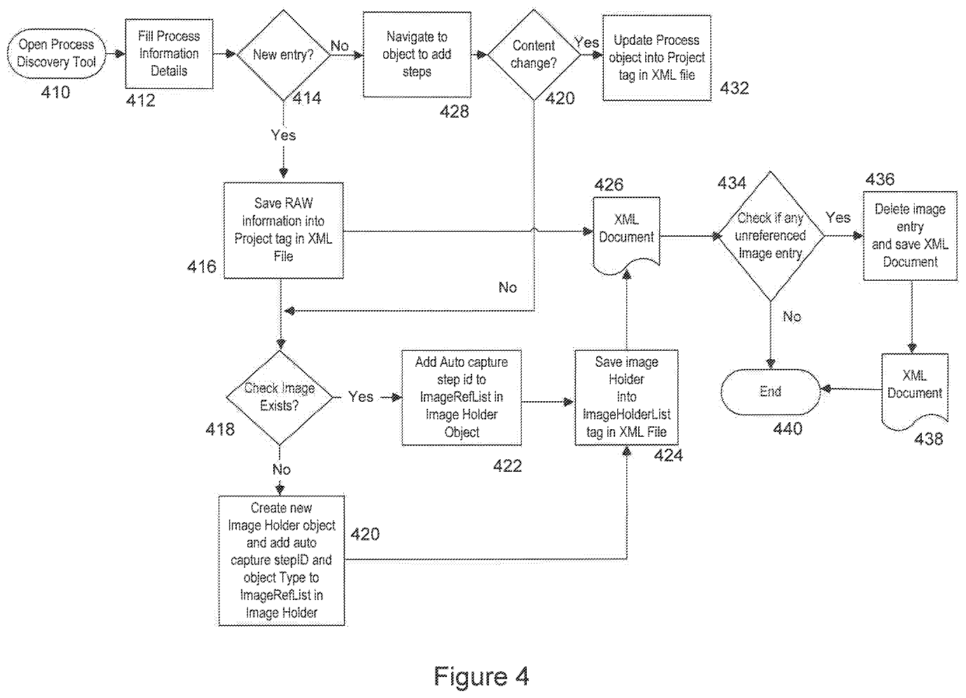

FIG. 4 is an exemplary process discovery tool flowchart, according to an embodiment of the present invention. At step 410, a process discovery tool may be initiated. At step 412, process information details may be identified. At step 414, a determination may be made to identify whether an entry is new. If yes, information may be stored as a project tag at step 416. For example, raw information may be saved into a project tag in a XML file. This may exclude a screenshot. At step 418, an embodiment of the present invention may check whether the image exists. If not, a new Image Holder object may be created. An auto capture step ID and object type may be automatically added to an Image Reference List in an Image Holder object, at step 420. If an image does exist, an embodiment of the present invention may add an auto capture step ID to an image Ref List in an Image Holder Object at step 422. At step 424, an image Holder may be saved into an image Holder List tag in an XML file, as represented by 426.

If the entry is not a new entry, as determined at step 414, user interaction may be performed to navigate to an existing object to make edits, at step 428, At step 430, a determination may be made whether the content is changed. If not, an existing image may be checked at step 418. If the content is changed, process object may be updated into a project tag in the XML file at step 432. At step 434, an embodiment of the present invention may check if any unreferenced image entries exist. If yes, the image entry may be deleted and the XML document, represented by 438, may be saved at step 436. The process may then end at step 440.

While the process of FIG. 4 illustrates certain steps performed in a particular order, it should be understood that the embodiments of the present invention may be practiced by adding one or more steps to the processes, omitting steps within the processes and/or altering the order in which one or more steps are performed.

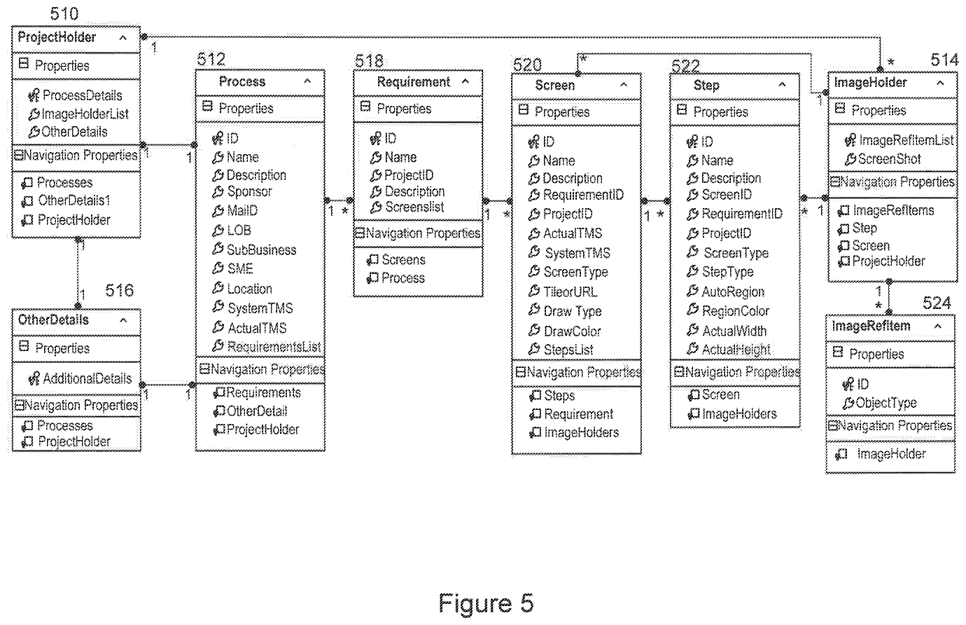

FIG. 5 is an exemplary illustration. of XML entities, according to an embodiment of the present invention. As shown in FIG. 5, each XML entity may include properties and navigation properties. XML entities may include ProjectHolder 510, Process 512, ImageHolder 514, Other Details 516, Requirement 518, Screen 520, Step 522, Image Holder 514 and Image Reference Item 524. FIG. 5 illustrates one exemplary format; other formats may be contemplated by the various embodiments of the present invention.

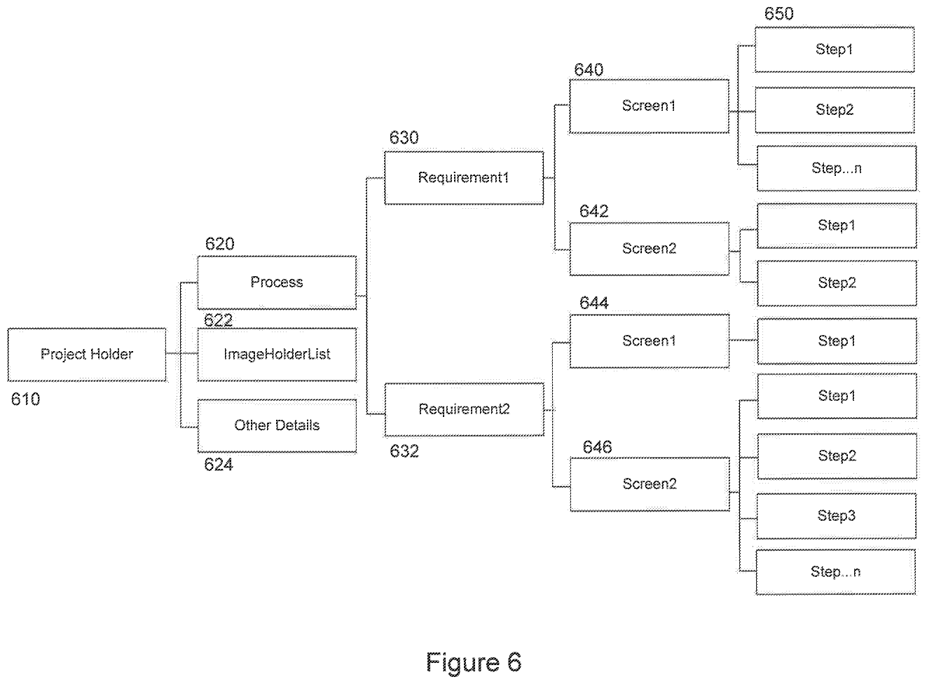

FIG. 6 is an exemplary illustration of XML entities, according to an embodiment of the present invention. As shown by FIG. 6, Project Holder 610 may include Process 620, Image Holder List 622 and Other Details 624. Process 620 may include Requirement 1 and Requirement 2, as represented by 630 and 632 respectively. Each requirement may have an associated series of Screens, represented by 640 and 642 for Requirement 1 and Screens 644 and 646 for Requirement 2. Each screen may have a series of steps, as shown by 650.

According to an exemplary illustration XML entities are detailed below:

<> Project

<> Name xds:string
<> Description xsd:anyType
<> ID xsd:string
<> SystemTMS xsd:unsignedByte
<> Actual TMS xsd:unsignedByte
<> Requirements

<> Requirement

<> Screens

<> Screen [1..*]

<> IsInEditMode xsd:boolean
<> Name xsd:string
<> SystemTMS xsd:unsignedByte
<> ActualTMS xsd:unsignedByte
<> ScreenType xsd:string
<> TitleOrURL xsd:anyType
<> ID xsd:string
<> RequirementID xsd:string
<> Description xsd:anyType
<> Screenshot xsd:anyType
<> Steps

<> ProcessStep [1..*]

<> IsInEditMode xsd:boolean
<> Name xsd:string
<> RequirementID xsd:string
<> ScreenID xsd:string
<> Description xsd:string
<> ScreenType xsd:string
<> Region
<> RegionColor xsd:anyType
<> RegionAuto xsd:string
<> Index xsd:anyType
<> Screenshot xsd:anyType
<> WindowTitle xsd:string
<> WindowParentTitle xsd:string
<> ActualHeight xsd:unsignedShort
<> ActualWidth xsd:unsignedShort
<> StepType xsd:string

<> DrawType xsd:string
<> DrawColor xsd:anyType

<> IsInEditMode xsd:boolean
<> Name xsd:string
<> ID xsd:string
<> ProjectID xsd:string

<> Applications xsd:anyType
<> Company xsd:string
<> Copyright xsd:string
<> Trademark xsd:string
<> BuildVersion xsd:unsignedByte
<> DotNetRunTimeVersion xsd:string

<> ImageHolderList

<> ImageHolder [1..*]

<> ImageRefList

<> Id xsd:string
<> Type xsd:string

<> Screenshot xsd:string

<> OtherDetails

<> AdditionalDetails xsd:anyType

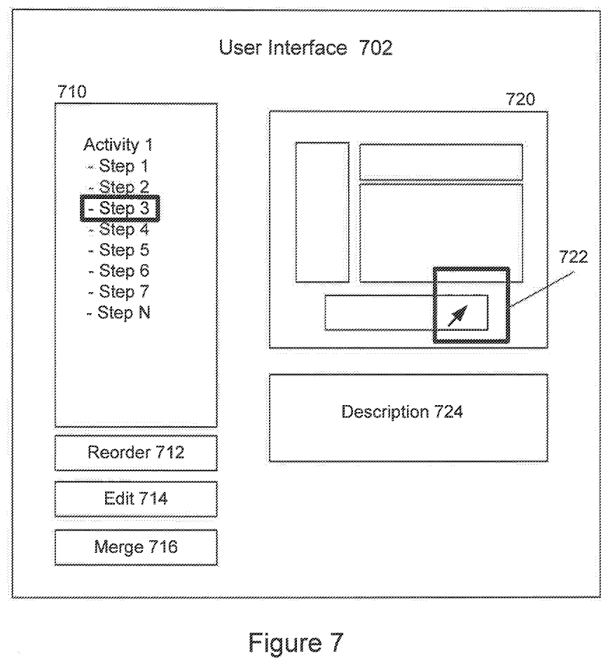

FIG. 7 is an exemplary illustration of an interactive user interface, according to an embodiment of the present invention. As shown in FIG. 7, User Interface 702 may include various sections and panels. For example, a series of steps may be identified at 710 that relate to an activity associated with a policy, regulation, standard, etc. Section 720 may display a screen shot corresponding to a step highlighted in 710, e.g., Step 3. Section 710 may display a series of screen shots and/or video of a user interaction where the user interaction may be highlighted by 722, User interaction may be represented by a cursor position. Additional context, description, instructions and/or commentary may be provided at Description 724. A user may perform various actions including Reorder 712, Edit 714, Merge 716, etc.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired, An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a process discovery tool, the system comprising:
a database that stores process information;
an interface that receives inputs from a user device via a communication network; and
a computer processor, coupled to the database and the interface, the computer processor configured to perform the steps of:
receiving, via an input, process information relating to a standard operating procedure (SOP) process;
identifying a series of steps executing the SOP process;
identifying user interaction for each step of the series of steps;
executing a capture responsive to each user interaction;
performing data masking to one or more data elements;
graphically highlighting each user interaction for each step of the series of steps; and
generating an output format that enables a review process.

2. The system of claim 1, wherein the process information is received via a user input.

3. The system of claim 1, wherein the process information is automatically received from a data source.

4. The system of claim 1, wherein the capture generates an XML file.

5. The system of claim 4, Wherein the XML file comprises Project Holder, Process and Image Holder List attributes.

6. The system of claim 5, wherein the Process attribute further comprises a series of Screens.

7. The system of claim 6, Wherein each Screen comprises a corresponding series of steps.

8. The system of claim 1, wherein the review process further enables a user to edit a process step.

9. The system of claim 1, wherein the review process further enables a user to reorder a process step.

10. The system of claim 1, wherein the output format comprises time and motion study data.

11. A method that implements a process discovery tool, the method comprising the steps of:
receiving, via an input, process information relating to a standard operating procedure process;
identifying, via a computer processor, a series of steps executing the SOP process;
identifying, via the computer processor, user interaction for each step of the series of steps;
executing, via the computer processor, a capture responsive to each user interaction;
performing, via the computer processor, data masking to one or more data elements;
graphically highlighting, via the computer processor, each user interaction for each step of the series of steps; and
generating, via the computer processor, an output format that enables a review process.

12. The method of claim 11, wherein the process information is received via a user input,

13. The method of claim 11, wherein the process information is automatically received from a data source.

14. The method of claim 11, wherein the capture generates an XML file.

15. The method of claim 14, wherein the XML tile comprises Project Holder, Process and Image Holder List attributes.

16. The method of claim 15, wherein the Process attribute further comprises a series of Screens.

17. The method of claim 16, Wherein each Screen comprises a corresponding series of steps.

18. The method of claim 11, wherein the review process further enables a user to edit a process step.

19. The method of claim 11, wherein the review process further enables a user to reorder a process step.

20. The method of claim 11, wherein the output format comprises time and motion study data.
